(19) United States
(12) Patent Application Publication
(10) Pub. No.: US 2026/0202284 A1
(43) Pub. Date: Jul. 16, 2026

(54) DEVICE FOR SIMULATING SEATBELT SLACK AND/OR FOR SIMULATING SEATBELT FORCES

(71) Applicant: ZF AUTOMOTIVE GERMANY GMBH, Alfdorf (DE)

(72) Inventors: Bartholomäus BRYLKA, Mannheim (DE); Kai-Ulrich MACHENS, Stuttgart (DE); Lukas HAGMANNS, Mutlangen (DE); Alexander STEPHAN, Schwäbisch Gmünd (DE)

(21) Appl. No.: 18/867,693

(22) PCT Filed: May 16, 2023
(86) PCT No.: PCT/EP2023/063081

§ 371 Date: Nov. 20, 2024

(30) Foreign Application Priority Data
May 24, 2022 (DE) 10 2022 113 098.3

(51) Int. Cl. G01M 99/00; B60R 22/18

(52) U.S. Cl. CPC G01M 99/008; B60R 22/18

(57) ABSTRACT

The invention relates to a device for simulating a belt slack and/or for simulating belt forces, comprising a guide (12) for a seatbelt (20) which includes static guide elements (14) and a movable deflection element (16) which is adjustable relative to the latter from an initial state via an intermediate state to a final state, and at least one inertial mass (18), wherein the guideway (17) for a seatbelt (20) predetermined by the deflection element (16) and the adjacent guide elements (14) is V-shaped in the initial state and the deflection element (16) and the inertial mass (18) do not interact, in the intermediate state is designed to be less V-shaped and the deflection element (16) and the inertial mass (18) interact, and the predetermined guideway (17) is at least approximately linear in the final state.

### TECHNICAL FIELD

The invention relates to a device for simulating a belt slack and/or for simulating belt loads.

### BACKGROUND

Seatbelt systems for vehicles usually include, apart from the seatbelt itself, a safety device in the form of one or more belt tensioners.

In a trigger scenario or shortly before a potential trigger scenario, belt tensioners provide a restraining effect for vehicle occupants by tensioning the seatbelts contacting the vehicle occupants by the belt tensioner, before and/or immediately after the forward movement of a vehicle occupant takes place and, if necessary, further occupant restraint devices are triggered. By tensioning the seatbelts, the belt slack (i.e., webbing loosely contacting the vehicle occupant) as well as the film reel effect (i.e., webbing loosely wound onto the belt reel) can be eliminated, allowing the vehicle occupant to participate in the vehicle deceleration at an earlier stage. Accordingly, a distinction is made between different types of belt tensioners.

On the one hand, comfort tensioners are known which are adapted to rotate the belt reel in the tensioning direction and to reversibly tension the webbing. The comfort tensioner typically comprises an electric motor, gearwheels and a coupling pawl. The coupling pawl can engage in a drive wheel coupled to the belt reel. In this way, the movement of rotation of the electric motor can be applied to the belt reel through the gearwheels, when the coupling pawl is engaged, and it can be rotated in the tensioning direction. It is a substantial feature of a comfort tensioner that the belt reel can be released again or can be rotated in the unwinding direction, for example if the situation which triggered comfort tensioning, such as full brake application, is no longer given.

On the other hand, power tensioners are known. They tension the belt in a trigger scenario and are usually driven pyrotechnically. In so doing, by igniting a propellant charge in a gas generator, sufficient energy for belt tensioning is provided within split second to rotate the belt reel in the tensioning direction.

It is important to test and check both the comfort tensioner and the power tensioner by experiment during the developing process. On the basis of the findings established by experiment, the seatbelt system is further developed.

According to the previous state of the art, this is done by a test setup with a vehicle seat, a dummy and the seatbelt system as it is installed in the vehicle. During the test, a situation of restraint is simulated so that the belt tensioners are triggered and fix the dummy in the vehicle seat.

It is a drawback in this case that such a test setup is extremely time-consuming and expensive. Moreover, such a test setup requires a lot of space.

In addition, it is expensive to record measured values for detecting the seatbelt behavior when the belt tensioner is triggered. This is due, inter alia, to the fact that for recording the measured values plural sensors have to be distributed on and attached to the test setup. Moreover, the reproducibility for such a test setup may be possible only to a limited extent, which can also negatively affect the comparability of the tests with each other.

### SUMMARY

It is the object of the invention to provide a device which can replace the previous complicated test setups, can be operated at lower costs, requires less space and provides more reproducible results.

This given object is achieved according to the invention by a device for simulating a belt slack and/or for simulating belt loads, comprising a guide for a seatbelt which includes static guide elements and a movable deflection element which is adjacent to two static guide elements and which is adjustable relative to the latter from an initial state via an intermediate state to a final state, and comprising at least one inertial mass, wherein the guideway for a seatbelt predetermined by the deflection element and the adjacent guide elements is V-shaped in the initial state and the deflection element and the inertial mass do not interact, is designed to be less V-shaped in the intermediate state and the deflection element and the inertial mass interact in such a way that the mass inertia of the inertial mass counteracts a movement of the deflection element toward the final state, and the predetermined guideway of the webbing between the static guide elements is at least approximately linear in the final state.

It is the basic idea of the invention to exchange the above-mentioned complicated test setup including a dummy for a kinematically simpler substitute system which nevertheless simulates all physical influences prevailing during the restraining operation which are present, for example, due to the belt extension and the vehicle occupant and/or the dummy.

The frictional resistances caused by the dummy contact and the redirection of the seatbelt are imitated in the device by the extension of the seatbelt along the guide, the surface finish of the guide elements and of the deflection element as well as the wrapping angle of the seatbelt around the guide elements and the deflection element.

In the case of high seatbelt accelerations which are specifically above 5000 g, the dynamic resistance of the seatbelt depends on the non-linear seatbelt yieldingness and the seatbelt inertia. This is also taken into consideration in the device by the guide along which the seatbelt is guided and by the use of seatbelts whose length corresponds to that used in the classical test setup.

The yieldingness of the shoulder, the thorax and the pelvis as well as the belt slack which is caused, for example, by clothing or a seatbelt buckle that does not abut on the vehicle seat or on the vehicle occupant, is simulated by the movable deflection element, the inherent inertia of the movable deflection element as well as by the interaction with the inertial mass. In addition, while the seatbelt is tensioned, the guide allows extensional waves to propagate inside the seatbelt which have an influence depending on time and inertia on the reduction of the belt slack, as this would also be the case in the classical test setup.

Therefore, the initial state in which the predetermined guideway for the seatbelt is V-shaped stands for a state in which the belt has a certain belt slack and extends along the vehicle occupant and/or the dummy so that it only lies on the surface and the body does not yet yield in the region of the shoulder, the thorax and the pelvis.

In the intermediate state in which the V shape of the guideway is designed to be weaker already, thus a state is represented in which the belt slack already starts to be reduced and the seatbelt acts initially slightly and then increasingly strongly upon the body so that the latter yields in the above-mentioned regions with the effective length of the seatbelt being reduced.

The inertial mass interacting with the deflection element which counteracts the movement of the deflection element toward the final state accordingly stands for the inertial resistance of all masses accelerated by the webbing in the system which builds up when the yieldingness and the belt slack in the system are increasingly decreased.

The approximately linear guideway in the final state is symbolic of a seatbelt that fixes the vehicle occupant and/or the dummy in the seat while being tensioned. In this state, there is virtually no more belt slack.

The deflection element is adjusted starting from the initial state via the intermediate state toward the final state by activating the belt tensioners which reduce the effective length of the seatbelt extending along the guide so that the deflection element is inevitably moved out of the initial state.

Accordingly, at first the comfort tensioner is activated which reduces the belt slack inside the guide and possibly moves the deflection element already slowly out of the initial state. The belt slack can also be reduced by simulating the forward movement of the occupant. For this purpose, an additional actuator can act upon the webbing, for example.

The following activation of the power tensioner entails an abrupt increase in the load acting inside the seatbelt so that the deflection element is suddenly strongly accelerated. While the deflection element performs such accelerated movement in the intermediate state, it impacts on the inertial mass which counteracts the accelerated movement by its mass inertia and, in this way, reduces the acceleration of the deflection element.

A device of this type can be realized in an extremely space-saving manner. Additionally, this device allows to provide reproducible results due to always identical environmental conditions.

Further, various seatbelt extensions can be easily realized by converting the static guide elements.

Moreover, also by adaptation of the deflection element and the deflection thereof, a wide variety of scenarios with different body yieldingness and belt slacks in the system can be realized.

Such a design further facilitates recording of measured data.

According to one aspect of the invention, the deflection element can be pivoted around a first axis. This allows the movable deflection element to be adjusted relative to the adjacent guide elements and to be movable from the initial state via the intermediate state to the final state in this way.

The deflection element can have a bar the one end of which is supported in the area of the first axis. The pivoting movement of the deflection element can be adjusted through the length of the bar.

The inertial mass can be pivoted around a second axis. This allows the inertial mass, as soon as it interacts with the deflection element in the intermediate state, to counteract only the movement of the deflection element toward the final state by the inherent mass inertia while nevertheless simultaneously admitting a movement of the deflection element.

Preferably, plural individual inertial masses can be provided, wherein the mass inertia of the inertial masses can successively counteract, in the intermediate state of the deflection element, stepwise a movement toward the final state.

In this way, an increase in the mass inertia counteracting the deflection element can be realized via the movement toward the final state. This means that the mass inertia counteracting the deflection element is initially low and increases successively as with an increasing movement more and more inertial masses counteract the movement of the deflection element toward the final state.

Consequently, this results in the fact that the deflection element which is moved from the initial state via the seatbelt tensioned by the belt tensioners into the intermediate state and, due to the activation of the power tensioner, performs an accelerated movement is slowed down again by the inertial masses. Analogously, or additionally, this can also take place by the activation of the actuator which simulates the forward movement of the occupant.

Advantageously, a locking mechanism for the inertial mass can be provided. When the deflection element has reached the final state and is no longer in contact with the inertial mass, such locking mechanism ensures the inertial mass to be fixed and not to bypass the deflection element, for example, when it impacts on the seatbelt.

Advantageously, a first positioning holder on which the deflection element rests in the initial state can be provided for the deflection element, and/or a second positioning holder on which the inertial mass rests, when a deflection element is in the initial state, and rests at least partially, when a deflection element is in the intermediate state, can be provided for the inertial mass.

Therefore, the first positioning holder allows the deflection element to be held in a defined initial state. It is also imaginable that the positioning holder can be adjusted as required so that the initial state of the deflection element can also be individually adapted.

The second positioning holder for the inertial mass and/or the inertial masses serves to position the latter in a defined manner so that, at the desired moment, it impacts on the inertial mass(es) when the deflection element is moved in the intermediate state. In this case, too, it is imaginable that the second positioning holder can be adjusted individually to adjust the inertial mass(es).

A first spring element can be assigned to the deflection element, and/or a second spring element can be assigned to the inertial mass.

Each of the two spring elements can be either a tension spring or a compression spring.

The first spring element assigned to the deflection element preferably acts in such a way that the deflection element is fixed on the first positioning holder as long as no loads act through the seatbelt. Thus, the spring load acts toward the positioning holder.

This is equally applicable to the second spring element which is intended to maintain the inertial mass on the second positioning holder until the deflection element interacts with the inertial mass(es).

It is furthermore also possible that the first spring element acts upon the bar of the deflection element.

Accordingly, it applies to both spring elements that they counteract the direction of movement of the deflection element from the initial state toward the final state by a spring load. This is done by the second spring element indirectly via the inertial mass(es).

Preferably, the first spring element can act in the direction of the first positioning holder upon the deflection element, and/or the second spring element can act in the direction of the second positioning holder upon the inertial mass.

Moreover, a comfort tensioner and/or a power tensioner may be provided each of which is attached to a holder. The holders allow to adapt and quickly replace the comfort tensioner and the power tensioner depending on the test setup. The holders are positioned so that each of them is arranged in the area of the guide in which the respective ends of the seatbelt are located.

### BRIEF DESCRIPTION OF THE DRAWINGS

In the following, the invention will be described on the basis of an embodiment shown in the attached drawings, wherein:

FIG. 1 schematically shows a device according to the invention including a guide;

FIG. 2 shows a section of the guide of the device according to the invention including a deflection element in an initial state and inertial masses;

FIG. 3 shows the section of the guide of the device according to the invention including the deflection element and inertial masses according to a second variant;

FIG. 4 shows a diagram with a graphical representation of the tensile force and the displacement of the seatbelt over time when the belt is tensioned;

FIG. 5 shows the section of FIG. 2 with the deflection element in an intermediate state;

FIG. 6 shows the section of FIG. 2 with the deflection element in the intermediate state;

FIG. 7 shows the section of FIG. 2 with the deflection element in the intermediate state and about to contact one of the inertial masses;

FIG. 8 shows the section of FIG. 2 with the deflection element in the intermediate state and in contact with one of the inertial masses;

FIG. 9 shows the section of FIG. 2 with the deflection element in the intermediate state and in contact with all inertial masses; and

FIG. 10 shows the section of FIG. 2 with the deflection element in a final state.

### DESCRIPTION

FIG. 1 illustrates a device 10 for simulating a belt slack and for simulating belt loads including a guide 12 for the webbing.

The guide 12 comprises static guide elements 14 and a movable deflection element 16 which is adjacent to two static guide elements 14 and which is adjustable relative thereto from an initial state via an intermediate state to a final state. Explanations concerning the different states will follow below.

The static guide elements 14 and the movable deflection element 16 predetermine a guideway 17 along which a seatbelt 20 can extend.

Further, a displacement sensor 21 for detecting the webbing movement is provided to determine the load present along the guideway 17 and, thus, on the seatbelt 20.

In addition, the device 10 comprises an inertial mass 18 assigned to the movable deflection element 16.

Moreover, the device 10 includes two holders 22, one holder 22 serving to arrange a reversible comfort tensioner 24 to be tested and the other holder 22 serving to arrange a power tensioner 26 to be tested. In this case, the arrangement of a comfort tensioner is in particular an option, i.e., the device can also be used only with a power tensioner 26 as the only tensioning element.

The guideway 17 extends in such a manner that the ends 28 of the seatbelt 20 introduced into the guide 12 are guided toward the holders 22 so that the latter can be received by the reversible comfort tensioner 24 to be tested and/or the power tensioner 26.

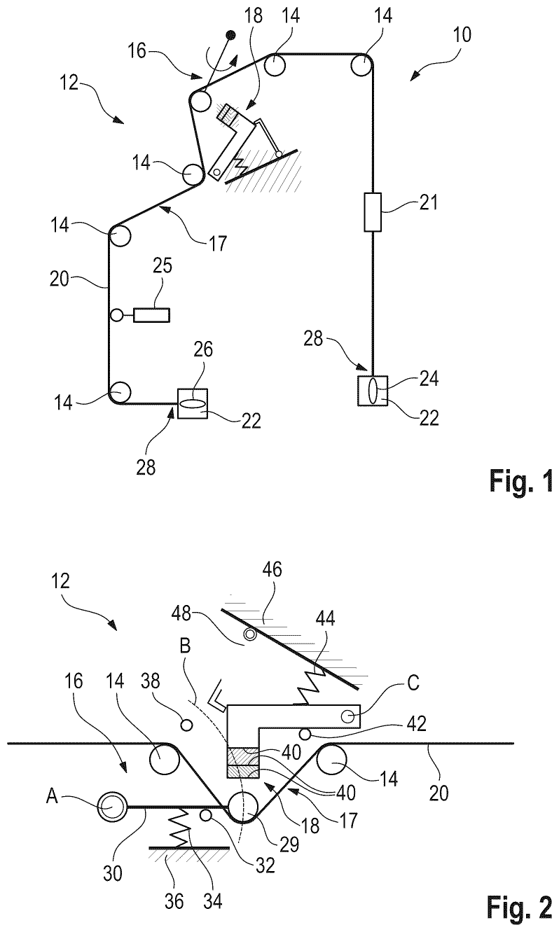

FIG. 2 schematically illustrates the section of the guide 12 and the guideway 17 on which the deflection element 16 in the initial state and the inertial masses 18 are arranged.

The movable deflection element 16 is in an initial state. In so doing, together with the two adjacent static guide elements 14, it predetermines a V-shaped extension of the guideway 17 for the seatbelt 20 in the area between the static guide elements 14. One of the static guide elements may further be provided with a force meter.

The movable deflection element 16 can be pivoted around a first axis A.

Furthermore, it includes a deflection guide 29 and a bar 30, the one end of the bar 30 being connected to the deflection guide 29 and the other end of the bar being supported in the area of the first axis A.

If a pivoting movement of the deflection element 16 occurs, the deflection guide 29 moves along a motion path B.

The guideway 17 extends along the outer contour of the deflection guide 29.

The deflection element 16 in the initial state rests on a first positioning holder 32 in the area of the bar 30, wherein, in the area of the bar 30, a first spring element 34 is arranged which is designed as a tension spring and the opposite end of which is fixed to a holder 36 so that the spring load caused by the first spring element 34 acts in such a manner that the deflection element 16 is held in the direction of the positioning holder.

Moreover, an end stop 38 for the deflection element 16 is provided.

The inertial masses 18 is L-shaped, with parts of the inertial masses 18 protruding into the V-shaped area of the guideway 17. Alternative designs of the inertial masses 18 are easily possible.

Moreover, they have contact portions 40 facing the deflection guide 29 of the deflection element 16 which extend successively along the motion path B.

Furthermore, the inertial masses are supported pivotally around a second axis C at their ends opposite to the contact portions 40.

Additionally, a second positioning holder 42 is provided on which the inertial masses 18 rest as long as there is no contact between the contact portions 40 and the deflection guide 29.

Further, a second spring element 44 is provided which is designed as a compression spring and which acts by the one end upon the side of the inertial masses 18 opposite to the second positioning holder 42 and the other end of which is supported by a holder 46 so that the inertial masses are urged toward the second positioning holder 42 by the spring load of the second spring element 44.

A locking mechanism 48 assigned to the inertial masses 18 is additionally provided on the holder 46.

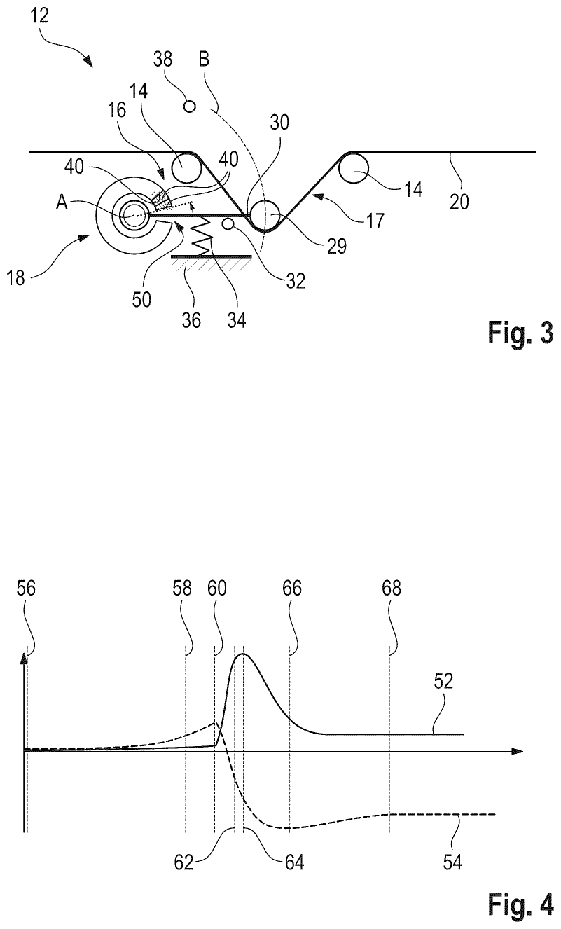

FIG. 3 illustrates another variant of the inertial masses. In contrast to the variant shown in FIG. 2, in this variant the inertial masses 18 are arranged around the first axis A of the movable deflection element 16.

The inertial masses in this embodiment are ring-shaped, each of the inertial masses having an open ring segment 50. The dimensions of the open ring segment 50 are different from each other so that the contact portions 40 are arranged to be offset against each other.

The bar 30 extends from the open ring segment 50 from the first axis A toward the deflection guide 29. A movement of the deflection guide 29 along the motion path B results in the fact the bar 30 gets successively in contact with the contact portions 40.

Hereinafter, the function of the device 10 will be explained on the basis of FIG. 2 and additionally on the basis of the FIGS. 4 to 10.

FIG. 4 illustrates a diagram having a first curve 52 and a second curve 54. The first curve 52 represents the tension force acting in the seatbelt 20 over time. The second curve 54 represents the displacement of the seatbelt 20 over time. The broken lines inserted in the diagram represent different points in time during operation of the device 10 and are used for reference in the further course of the explanations.

When operating the device 10, the tension force acting in the seatbelt 20 and/or the movement of the webbing is detected by the path sensor 21.

Furthermore, the displacement of the seatbelt 20 and, optionally, also the velocity of the displacement of the seatbelt 20 is detected by a camera system and a scale applied to the seatbelt.

Also, further different parameters are measured.

As already mentioned in the foregoing explanations, FIG. 2 shows the deflection element 16 in the initial state. The deflection element 16 rests on the first positioning holder 32, and the guideway 17 of the seatbelt 20 shows a V-shaped extension in the area of the deflection element 16 and of the guide elements 14 adjacent to the deflection element 16. Both the displacement of the seatbelt and the tension force in the seatbelt are equal (see FIG. 4, position 56).

In the first step, a comfort tensioner 24 attached to the holder 22 starts to remove the belt slack in the system, causing part of the seatbelt 20 to move toward the comfort tensioner 24. Alternatively, or additionally, the belt slack is removed by the forward movement of the occupant. This is simulated by the actuator 25. In this way, the seatbelt 20 is pretensioned so that a tension force builds up in the seatbelt 20 (see FIG. 4, position 58).

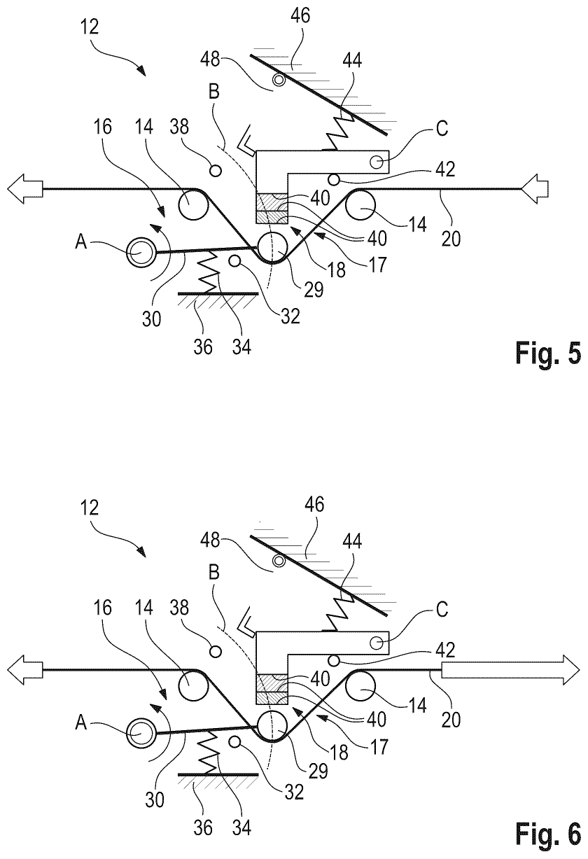

This is shown in FIG. 5, the displacement of the seatbelt 20 is indicated schematically by arrows and the amount of displacement of the seatbelt 20 is exemplified by the length thereof.

At the same time, the deflection element 16 swivels anti-clockwise from the initial state into an intermediate state so that also the deflection guide 29 of the deflection element 16 moves along the motion path B.

The deflection element 16 is no longer in contact with the first positioning holder 32.

The V shape of the guideway 17 starts to flatten. In other words, the angle measured on the inside between the two legs of the “V” is increased.

The above-mentioned tension force building up (see FIG. 4, position 58) in the seatbelt 20 is reached, as a spring load acting clockwise around the axis A and, thus, against the direction of movement B of the deflection element 16 is applied by the first spring element 34 to the deflection element 16.

In the next step, the power tensioner 26 is activated while the reversible comfort tensioner 24 is still tensioning the seatbelt 20.

As a result, a displacement of the seatbelt 20 occurs abruptly in the direction of the power tensioner 26 (see FIG. 6, large arrow on the right). This is accompanied by a strong increase in the tension force within the seatbelt 20 (see FIG. 4, position 60).

Moreover, extensional waves which may propagate freely along the guideway 17 due to the guide 12 are formed in the seatbelt 20.

In addition, this results in the fact that the deflection element 16 is strongly accelerated anti-clockwise around the first axis A so that the deflection guide 29 performs an accelerated movement along the motion path B.

The deflection element 16 is still in the intermediate state and continues moving toward the contact portions 40 of the inertial masses 18.

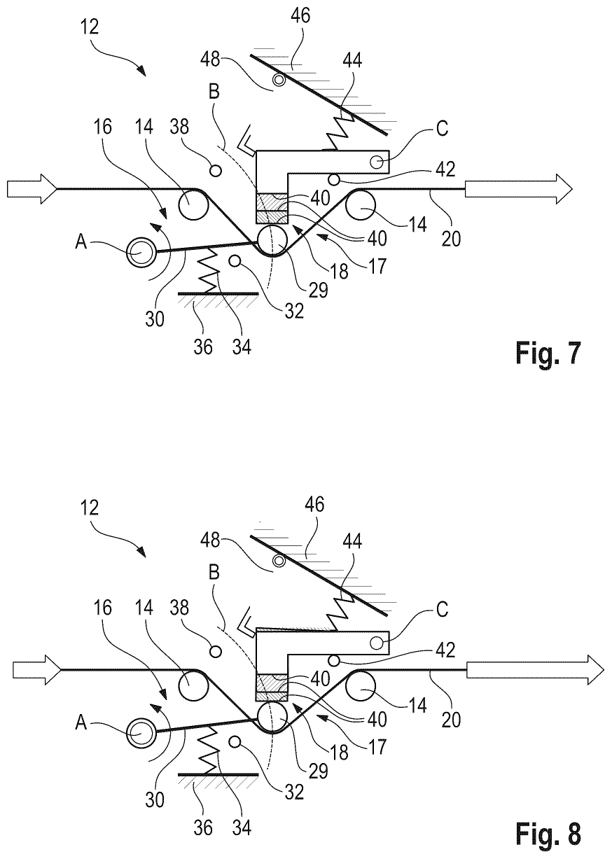

Shortly before the deflection element 16 and/or the deflection guide 29 contacts the contact portion 40, the seatbelt reaches its maximum velocity due to the displacement (see FIG. 4, position 62). There is exclusively a displacement of the seatbelt 20 toward the power tensioner 26 (see FIG. 7, both arrows to the right).

FIG. 8 illustrates the deflection element 16 in the intermediate state after the deflection guide 29 impacted on the contact portion 40 of the first inertial mass 18.

The V shape of the guideway 17 becomes even flatter.

As a result, the acceleration acting on the deflection element 16 is decreased, while the inertial mass 18 is accelerated by the contact with the deflection element 16.

The tension force within the seatbelt 20 reaches its maximum (see FIG. 4, position 64) while the power belt tensioner 26 is decelerated due to the resistances present in the system so that also the velocity of the seatbelt 20 starts to decrease.

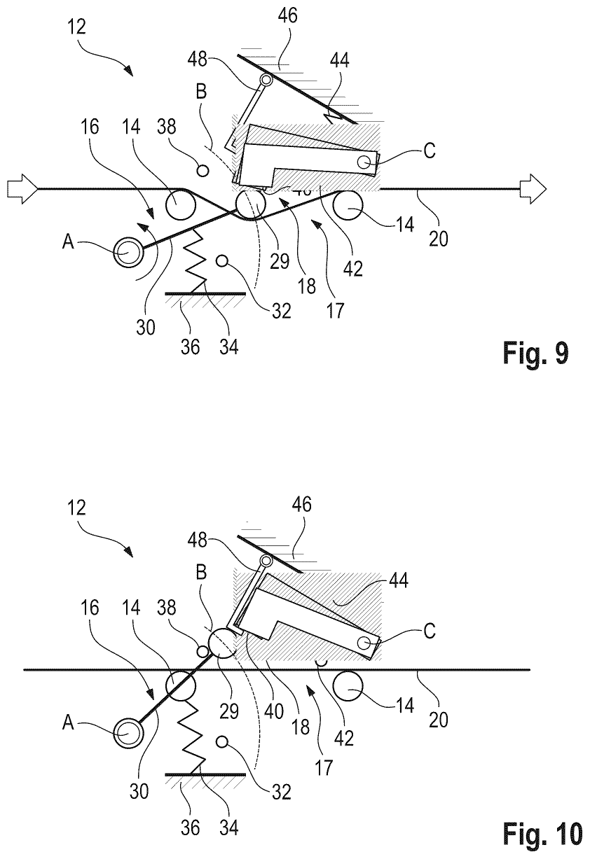

As is shown in FIG. 9, the deflection element 16 continues moving anti-clockwise and, in so doing, successively impacts on the contact portions 40 of the second and third inertial masses 18 so that the movement of the deflection element 16 is additionally decelerated, as the inertial masses thereof act against the movement thereof along the motion path B.

In addition, also the spring load of the second spring element 44 counteracts the direction of movement of the deflection element 16.

The V-shaped extension of the guideway 17 is already significantly less distinct than in the initial state. Additionally, also the tension force is reduced, wherein both the tension force in the seatbelt 20 and the displacement of the seatbelt 20 slowly approach a defined value so that the tension force in the seatbelt 20 causes a defined constant restraining force and at least approximately no change of the displacement of the seatbelt 20 will occur (see FIG. 4, position 66).

Since the power belt tensioner 26 only results in a small displacement of the seatbelt 20, the latter is about to lock so as to maintain the tension force within the seatbelt 20 (see FIG. 9, small arrow on the right).

FIG. 10 illustrates the deflection element 16 in the final state. The movement of the deflection element 16 is limited by the end stop 38 which acts upon the bar 30.

The inertial masses 18 are kept in position in a deflection element 16 in the final state by the locking mechanism 48 so as to prevent them from getting in contact with the seatbelt 20.

Since the movable deflection element 16 and/or the deflection guide 29 thereof is no longer in contact with the seatbelt 20, there is provided an approximately linear guideway 17 of the seatbelt 20 between the static guide elements 14 which are adjacent to the deflection element 16.

When the final state is reached, the power belt tensioner 26 is locked. Both the tension force and the displacement of the seatbelt 20 behave at least approximately constant in the final state (see FIG. 4, position 68). Changes in the curve progression can be based on a load limitation, for example, which results in the fact that seatbelt 20 is extended.

1-11. (canceled)

12. A device for simulating a belt slack and/or for simulating belt forces, comprising
a guide (12) for a seatbelt (20) which includes static guide elements (14) and a movable deflection element (16) which is adjacent to two static guide elements (14) and which is adjustable relative to the latter from an initial state via an intermediate state to a final state, and
at least one inertial mass (18),
wherein the guideway (17) for a seatbelt (20) predetermined by the deflection element (16) and the adjacent guide elements (14) is V-shaped in the initial state and the deflection element (16) and the inertial mass (18) do not interact, in the intermediate state is designed to be less V-shaped and the deflection element (16) and the inertial mass (18) interact so that the mass inertia of the inertial mass (18) counteracts a movement of the deflection element (16) toward the final state, and the predetermined guideway (17) is at least approximately linear in the final state.

13. The device according to claim 12, wherein the deflection element (16) can be pivoted around a first axis (A).

14. The device according to claim 13, wherein the deflection element (16) includes a bar (30) the one end of which is supported in the area of the first axis (A).

15. The device according to claim 12, wherein the inertial mass (18) can be pivoted around a second axis (C).

16. The device according to claim 12, wherein the inertial mass (18) pivots around the first axis (A).

17. The device according to claim 12, wherein plural individual inertial masses (18) are provided, wherein the mass inertia of the inertial masses (18) in the intermediate state of the deflection element (16) successively counteracts a movement stepwise toward the final state.

18. The device according to claim 12, wherein a locking mechanism (48) for the inertial mass (18) is provided.

19. The device according to claim 12, wherein for the deflection element (16) a first positioning holder (32) is provided on which the deflection element (16) rests in the initial state, and/or in that for the inertial mass(es) (18) a second positioning holder (42) is provided on which the inertial mass(es) (18) rest(s) when a deflection element (16) is in the initial state and rest(s) at least partly when a deflection element (16) is in the intermediate state.

20. The device according to claim 12, wherein a first spring element (34) is assigned to the deflection element (16) and/or a second spring element (44) is assigned to the inertial mass (18).

21. The device according to claim 20, wherein the first spring element (34) acts upon the deflection element (16) in the direction of the first positioning holder (32) and/or in that the second spring element (44) acts upon the inertial mass (18) in the direction of the second positioning holder (42).

22. The device according to claim 12, wherein a reversible comfort tensioner (24) and/or a power tensioner (26) is/are provided each of which is attached to a holder 22.
